(19) United States
(12) Patent Application Publication
(10) Pub. No.: US 2017/0176914 A1
(43) Pub. Date: Jun. 22, 2017

(54) PHOTOSENSITIVE DRUM DRIVING COMPONENT AND A CARTRIDGE COMPRISING THE SAME

(71) Applicant: SHENZHEN CLORD PRINTING CONSUMABLES CO., LTD, Shenzhen (CN)

(72) Inventor: Xiao Wenyi, Shenzhen (CN)

(73) Assignee: SHENZHEN CLORD PRINTING CONSUMABLES CO., LTD, Shenzhen (CN)

(21) Appl. No.: 14/994,184

(22) Filed: Jan. 13, 2016

(30) Foreign Application Priority Data
Dec. 21, 2015 (CN) 201510965006.7

(51) Int. Cl. G03G 15/00

(52) U.S. Cl. CPC G03G 15/757; G03G 21/1671

(57) ABSTRACT

The invention relates to a photosensitive drum driving component comprising a gear coordinating with the photosensitive drum and a driving force receiver that can receive rotational driving force. The upper part of the driving force receiver is installed with a driving force receiving head and the outer wall at the lower part of the driving force receiver projects more than three protrusions. The inner wall of the gear is installed with more than three chutes along the direction of the gear axis. The top of the chute is installed with a barrier structure and the side wall of the chute is connected with a track groove which connects the top of the gear and the chute. Each protrusion enters the chute from the track groove and may be installed as sliding along the track groove. The protrusion slides in the chute, which realizes rotational transmission between the driving force receiver and the gear structure. The driving force receiver is not easily disengaged from the gear structure and thus has a low failure rate and high stability. The invention further provides a process cartridge (cartridge) comprising the photosensitive drum driving component.

### TECHNICAL FIELD

The invention relates to the field of printer technology, specifically a photosensitive drum driving component and a cartridge comprising the photosensitive drum driving component.

### BACKGROUND ART

Laser printer is a widely applied printing and imaging device, which usually comprises a paper delivering mechanism, a driving mechanism and a detachable cartridge (which is also called a process cartridge). The detachable cartridge comprises a toner cartridge and at least one rotation member which may be a developing member, a photosensitive member, a charging member or a transmission gear. One end of the rotation member is installed, with a driving component. Linking with the driving mechanism is realized through the driving component so as to lead the rotation member to rotate through the driving component under the drive of the driving mechanism. Take the photosensitive member as an example, under the driving effect of the driving mechanism, the rotation of the photosensitive member can transfer the toner in the toner cartridge onto the printing medium according to presupposed images.

The Chinese patent application—Driving assembly, photosensitive drum unit and processing cartridge (application No. 201420313988.2) improves a photosensitive drum driving component on the basis of FIGS. 10 and 11, but the assembly of the patent is rather complicated. FIG. 10 is a perspective view illustrating the installation of an existing photosensitive member and driving component; FIG. 11 is a perspective view illustrating an existing driving component. As shown in FIGS. 10 and 11, one end of a photosensitive member 001 is installed with a driving component comprising a gear structure 002 and a driving force receiver 003, wherein the photosensitive member 001 is linked to the driving force receiver 003 through the gear structure 002. The driving force receiver 003 is used for linking to the driving mechanism in the printer to receive and transfer the rotational driving force of the driving mechanism to the gear structure 002 such that the photosensitive member 001 is driven to rotate via the gear structure 002. Specifically, one end of the driving force receiver 003 is installed with a claw structure 004 for engaging with the driving mechanism and the other end is installed with a universal sphere 005. Correspondingly, one end of the gear structure 002 is installed with a recess 006 for coordinating with the universal sphere 005 and the other end is a cylindrical structure for linking with the photosensitive member 001. A connecting pin. 007 is used to successively pass through pinholes installed on the universal sphere 005 and gear structure 002 so that the universal sphere 005 can transfer the rotational driving force to the photosensitive member 001 through the gear structure 002.

The above driving force receiver 003 may be an all-in-one structure or a splitting structure. If it is an all-in-one structure, the driving component has the following installation procedures: installing the driving force receiver 003 into the recess 006 of the gear structure 002 through pressure welding and passing the connecting pin 007 through the pinholes installed on the gear structure 002. If it is a splitting structure, the above driving component has the following installation procedures: first assembling the claw structure 004, universal sphere 005 and connecting pin 007 to form the driving force receiver 003, then installing the driving force receiver 003 into the recess 006 of the gear structure 002 through pressure welding and passing the connecting pin 007 through the pinholes installed on the gear structure 002.

The structure and installation manner of the above driving component cause the driving force receiver 003 to be easily disengaged from the gear structure 002, and further result in a high failure rate and poor stability of the driving component.

### SUMMARY OF THE INVENTION

The invention intends to solve the technical problem of providing a photosensitive drum driving component with a driving force receiver not easily disengaged from the gear structure, having low high failure rate and high stability, and a cartridge comprising the photosensitive drum driving component.

The photosensitive drum driving component comprises a gear coordinating with the photosensitive drum (outside of the gear has engaging lines which are not drawn in the figures), and a driving force receiver that can receive the driving force. The upper part of the driving force receiver is installed with a driving force receiving head and the outer wall at the lower part of the driving force receiver projects more than three protrusions. The inner wall of the gear is installed with more than three chutes along the direction of the gear axis. The top of the chute is installed with a barrier structure and the side wall of the chute is connected with a track groove which connects the top (the top surface) of the gear and the chute. Each protrusion enters the chute from the track groove and may be installed as sliding along the track groove.

Preferably, the barrier structure installed on top of the chute is: a wall body on the top surface of the chute (beneficial effect, simple structure, achievable effect); when the protrusion abuts against the top surface of the chute, the driving force receiver reaches the upper limit service position.

Preferably, the depth of the chute is greater than the projecting length of the protrusion (so as to realize swing of the driving force receiver in the radial direction).

Preferably, the protrusion is a convex lump and the width of the chute is greater than the width of the convex lump (so as to realize slight swing of the driving force receiver in the peripheral direction).

Preferably, the protrusion is a convex column and the width of the chute is greater than the width of the convex column (so as to realize slight swing of the driving force receiver in the peripheral direction).

Preferably, the track groove extends from the top of the gear to the chute in form of arc.

Preferably, the track groove comprises a pin entrance groove and a connecting groove. The pin entrance groove extends downward from the top of the gear. The connecting groove connects the pin entrance groove and chute. The protrusion enters the chute from the pin entrance groove and the connecting groove.

Preferably, the connecting groove is connected to the middle or lower pan of the chute from the bottom of the pin entrance groove.

Preferably, there are three protrusions, all of which are installed on the outer wall of the driving force receiver. The number of either the chute or the track groove is three, and each track groove is corresponding to one chute.

Preferably, the track groove and chute are spaced and each track groove lies in a position in clockwise rotational direction of the corresponding chute.

Preferably, the middle part of the gear is installed with a terraced first blind hole. The chute and track groove are located on the wall of the first blind hole; the lower part of the driving force receiver penetrates into the upper hole section of the first blind hole; when the protrusion slides along the track groove, the driving force receiver slides along the gear axis.

Preferably, the chute is connected to the bottom surface of the gear. When the step of the first blind hole abuts against the bottom of the driving force receiver, the driving force receiver reaches the first lower limit service position.

Preferably, an elastic piece is further comprised. The lower part of the driving force receiver is installed with a second blind hole and the elastic piece is installed between the first and second blind holes.

Preferably, the elastic piece, i.e. the elastic buffer piece, may be rubber, metal spring, metal shrapnel or compressed sponge, etc.

Functions of the elastic piece: preventing the driving force receiver from disengaging during transport; allowing the driving force receiver to shrink when putting into the cartridge; during centring, realizing self-calibration through coordination between the elastic shrinkage and extension of itself and the arc transition structure of the driving force receiving head; during work, ensuring close integration of the driving fore receiver and the driving force exporter and ensuring the transmission force; when the protrusion lies at the joint of the track groove and the chute, the elastic piece is in the state of compression, which ensures that the protrusion does not slide out of the track groove during work.

Preferably, when the elastic piece reaches the limit of the state of compression, the driving force receiver reaches the second lower limit service position.

Preferably, when the protrusion lies in the upper limit service position and the first lower limit service position of the chute, the elastic piece is in a state of compression.

Preferably, the protrusion and the driving force receiver are arranged integrally.

Preferably, the protrusion is installed in the back of the driving force receiver detachably.

The invention further provides a cartridge.

The cartridge is applied in an electrophotographic image forming device and is detachably installed in the electrophotographic image forming device. It comprises a photosensitive member arranged along the longitudinal direction of the cartridge, and a rotational force driving component installed at one end of the photosensitive member and used for being engaged with a rotational force driving head inside the electrophotographic image forming device so as to transmit force to the photosensitive member. The rotational force driving component is a photosensitive drum driving component which comprises a gear coordinating with the photosensitive drum, and a driving force receiver that can receive the driving force. The upper part of the driving force receiver is installed with a driving force receiving head and the outer wall at the lower part of the driving force receiver projects more than three protrusions. The inner wall of the gear is installed with more than three chutes along the direction of the gear axis. The top of the chute is installed with a barrier structure and the side wall of the chute is connected with a track groove which connects the top of the gear and the chute. Each protrusion enters the chute from the track groove and may be installed as sliding along the track groove.

Preferably, the barrier structure installed on top of the chute is: a wall body on the top surface of the chute (beneficial effect, simple structure, achievable effect); when the protrusion abuts against the top surface of the chute, the driving force receiver reaches the upper limit service position.

Preferably, the depth of the chute is greater than the projecting length of the protrusion (so as to realize swing of the driving force receiver in the radial direction).

Preferably, the protrusion is a convex lump and the width of the chute is greater than the width of the convex lump (so as to realize slight swing of the driving force receiver in the peripheral direction).

Preferably, the protrusion is a convex column and the width of the chute is greater than the width of the convex column (so as to realize slight swing of the driving force receiver in the peripheral direction).

Preferably, the track groove extends from the top of the gear to the chute in form of arc.

Preferably, the track groove comprises a pin entrance groove and a connecting groove. The pin entrance groove extends downward from the top of the gear. The connecting groove connects the pin entrance groove and chute. The protrusion enters the chute from the pin entrance groove and the connecting groove.

Preferably, the connecting groove is connected to the middle or lower part of the chute from the bottom of the pin entrance groove.

Preferably, there are three protrusions, all of which are installed on the outer wall of the driving force receiver. The number of either the chute or the track groove is three, and each track groove is corresponding to one chute.

Preferably, the track groove and chute are spaced and each track groove lies in a position in clockwise rotational direction of the corresponding chute.

Preferably, the middle part of the gear is installed with a terraced first blind hole. The chute and track groove are located on the wall of the first blind hole; the lower part of the driving force receiver penetrates into the upper hole section of the first blind hole; when the protrusion slides along the track groove, the driving force receiver slides along the gear axis.

Preferably, the chute is connected to the bottom surface of the gear. When the step of the first blind hole abuts against the bottom of the driving force receiver, the driving force receiver reaches the first lower limit service position.

Preferably, an elastic piece is further comprised. The lower part of the driving force receiver is installed with a second blind hole and the elastic piece is installed between the first and second blind holes.

Preferably, when the elastic piece reaches the limit of the state of compression, the driving force receiver reaches the second lower limit service position.

Preferably, when the protrusion lies in the upper limit service position and the first lower limit service position of the chute, the elastic piece is in a state of compression.

Preferably, the protrusion and the driving force receiver are arranged integrally.

Preferably, the protrusion is installed in the back of the driving force receiver detachably.

The beneficial effects of the invention are: a photosensitive drum driving component comprises a gear coordinating with the photosensitive drum (outside of the gear has meshing lines which are not drawn in the figures), and a driving force receiver that can receive the driving force. The upper part of the driving force receiver is installed with a driving force receiving head and the outer wall at the lower part of the driving force receiver projects more than three protrusions. The inner wall of the gear is installed with more than three chutes along the direction of the gear axis. The top of the chute is installed with a barrier structure and the side wall of the chute is connected with a track groove which connects the top (the top surface) of the gear and the chute. Each protrusion enters the chute from the track groove and may be installed as sliding along the track groove. The protrusion slides in the chute, which realizes rotational transmission between the driving force receiver and the gear structure. The driving force receiver is not easily disengaged from the gear structure and thus has a low failure rate and high stability. The invention further provides a cartridge comprising the photosensitive drum driving component.

### BRIEF DESCRIPTION OF THE DRAWINGS

The photosensitive drum driving component of the invention is further described as follows in combination with the drawings.

FIG. 1 is an exploded view of Example 1 of the photosensitive drum driving component in the invention.

FIG. 2 is a schematic diagram showing one perspective of the gear in Example 1 of the photosensitive drum driving component in the invention.

FIG. 3 is a schematic diagram showing another perspective of the gear in Example 1 of the photosensitive drum driving component in the invention.

FIG. 4 is a schematic diagram showing one perspective of the driving force receiver in Example 1 of the photosensitive drum driving component in the invention.

FIG. 5 is a schematic diagram showing another perspective of the driving force receiver in Example 1 of the photosensitive drum driving component in the invention.

FIG. 6 is a schematic diagram showing one perspective of the gear in Example 2 of the photosensitive drum driving component in the invention.

FIG. 7 is a schematic diagram showing one perspective of the driving force receiver in Example 2 of the photosensitive drum driving component in the invention.

FIG. 8 is a schematic diagram show part of the cartridge in the invention.

FIG. 9 is an exploded view showing part of the cartridge in the invention.

FIG. 10 is a schematic diagram showing installation of the photosensitive drum and driving component in the prior art.

FIG. 11 is a section view showing the driving component in FIG. 10.

FIG. 12 is an exploded view of Example 1 of the photosensitive drum driving component in the invention.

In the drawings:

1—gear; 11—chute; 12—track groove; 121—pin entrance groove; 122—connecting groove; 13—first blind hole; 2—driving force receiver; 21—driving force receiving head; 22—protrusion; 23—second blind hole; 3—elastic piece; 4—photosensitive drum; 5—driving force transmitter; 51—pinhole; 6—pin.

### DETAILED DESCRIPTION

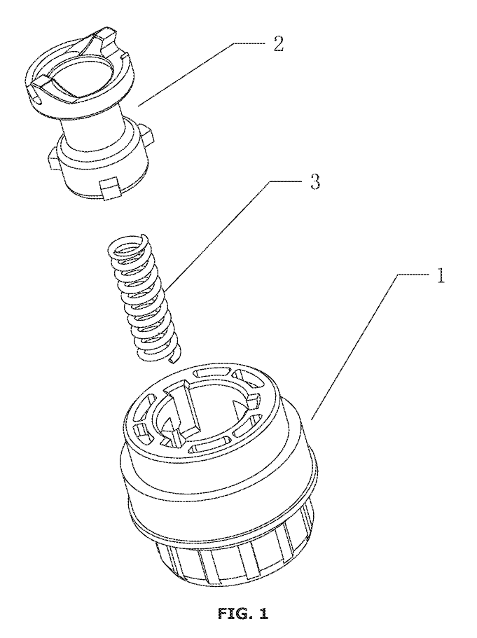

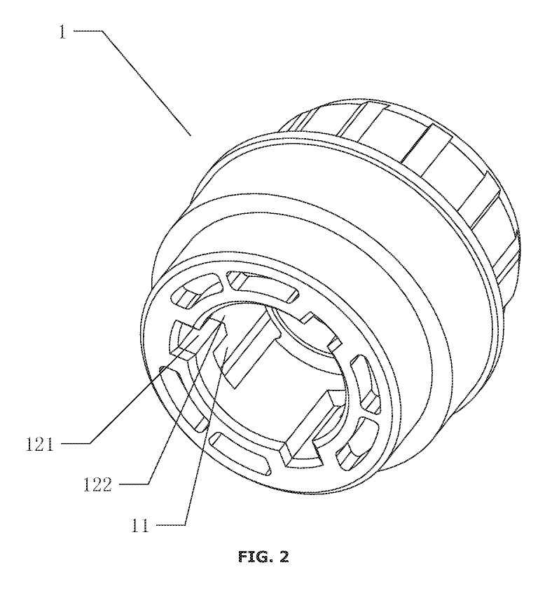

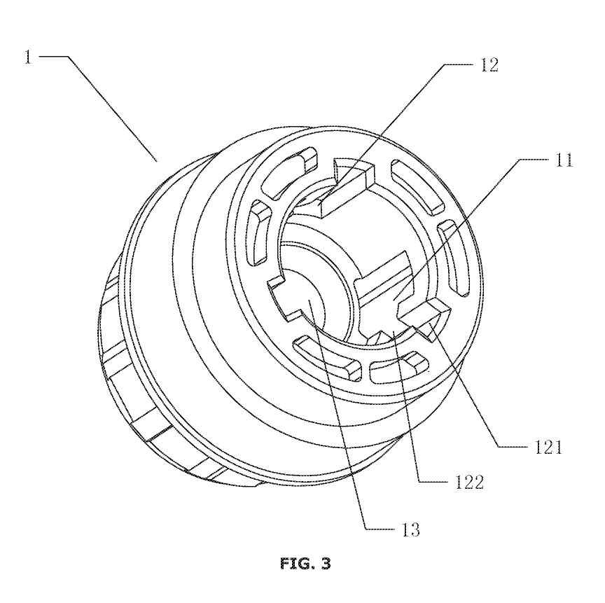

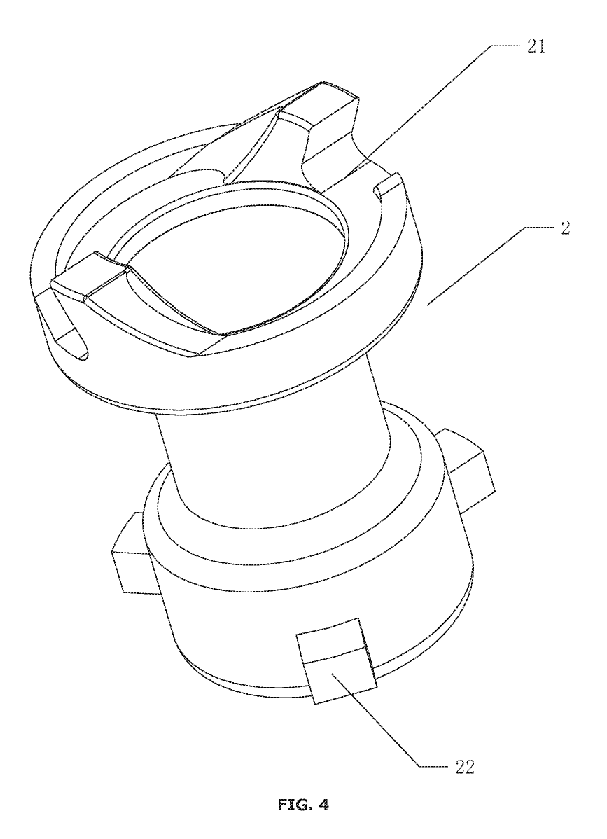

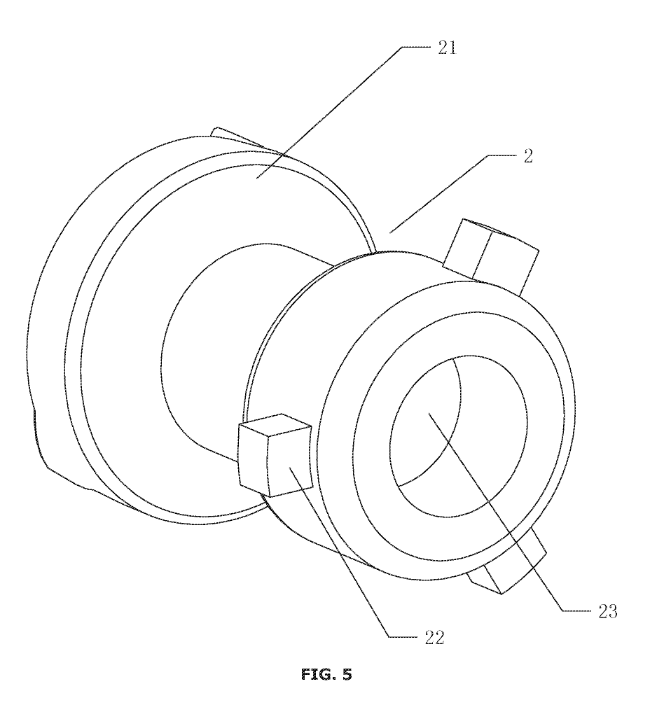

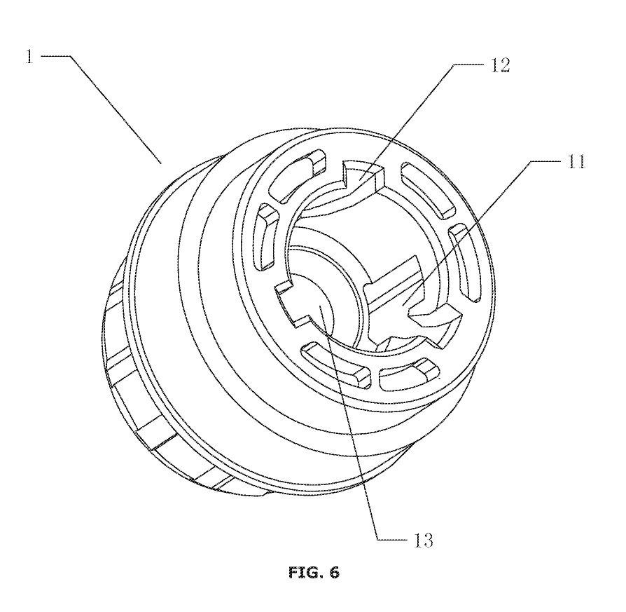

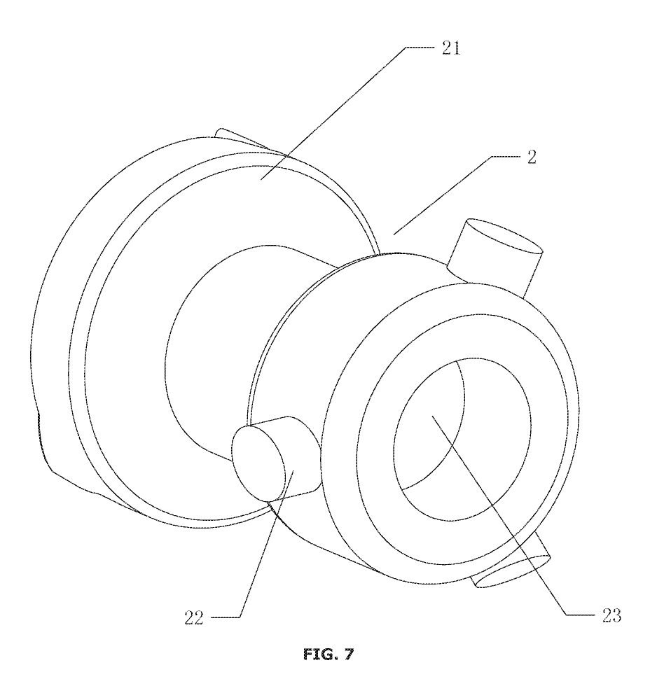

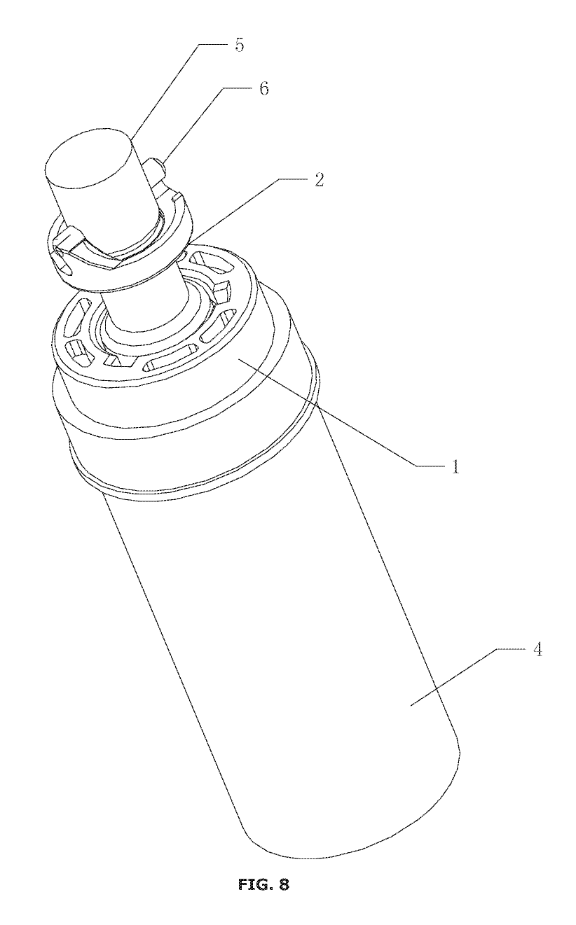

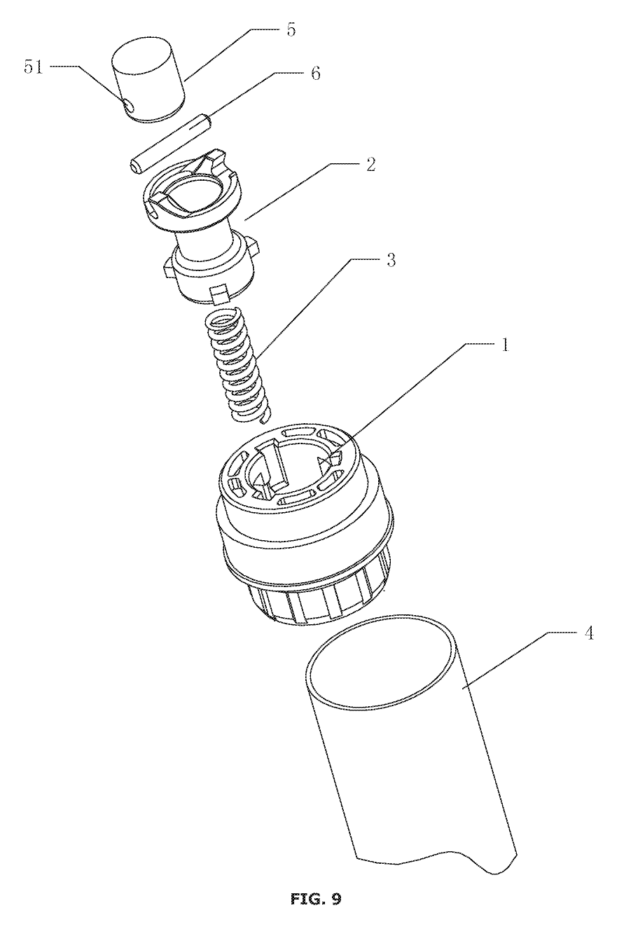

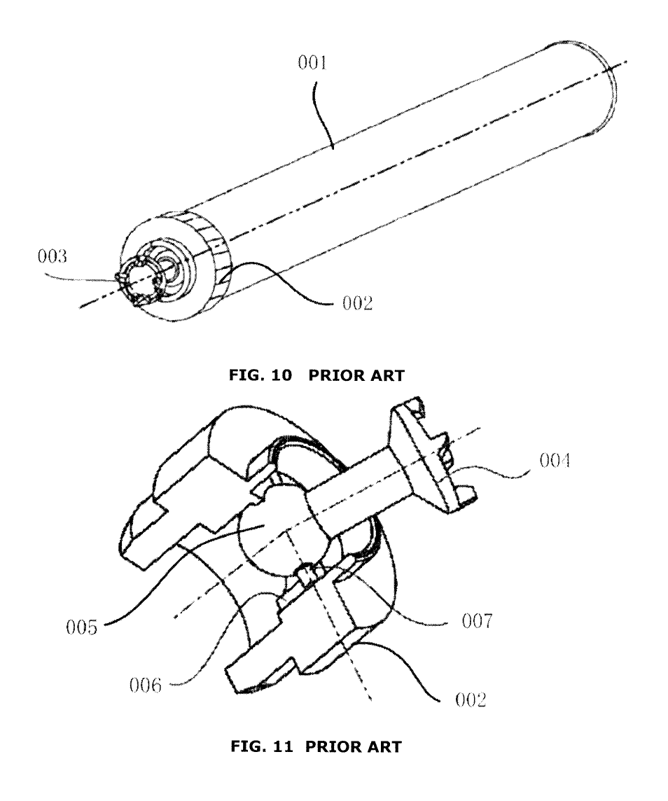

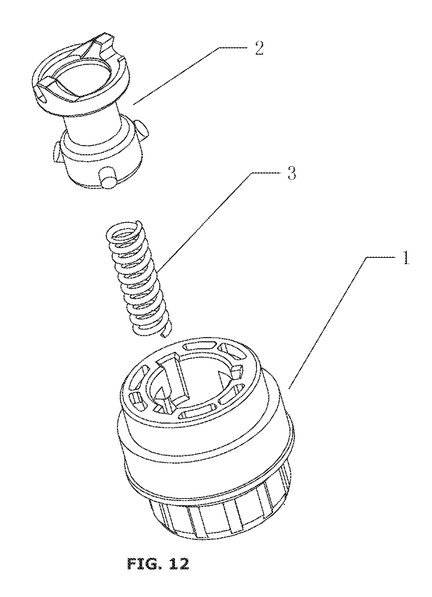

The technical solutions of the invention are further described as follows through embodiments in combination with FIG. 1-12.

### Example 1

A photosensitive drum driving component, comprising a gear 1 coordinating with the photosensitive drum and a driving force receiver 2 that can receive rotational driving force. The upper part of the driving force receiver 2 is installed with a driving force receiving head 21 and the outer wall at the lower part of the driving force receiver 2 projects more than three protrusions 22. The inner wall of the gear 1 is installed with more than three chutes 11 along the direction of the gear 1 axis. The top of the chute 11 is installed with a barrier structure and the side wall of the chute 11 is connected with a track groove 12 which connects the top of the gear 1 and the chute 11. Each protrusion 22 enters the chute 11 from the track groove 12 and may be installed as sliding along the track groove 12.

The protrusion 22 slides in the chute 11, which realizes rotational transmission between the driving force receiver and the gear structure. The driving force receiver is not easily disengaged from the gear structure and thus has a low failure rate and high stability. The invention further provides a cartridge comprising the photosensitive drum driving component.

In the Example, the barrier structure installed on top of the chute 11 is: a wall body on top surface of the chute 11. It has beneficial effects and a simple structure and can achieve the effect of preventing disengaging of the driving force receiver from the gear structure. When the protrusion 22 abuts against the top surface of the chute 11, the driving force receiver 2 reaches the upper limit service position.

In the Example, the depth of the chute 11 is greater than the projecting length of the protrusion 22 so as to realize swing of the driving force receiver in the radial direction.

In the Example, the protrusion 22 is a convex lump and the width of the chute 11 is greater than the width of the convex lump so as to realize slight swing of the driving force receiver 2 in the peripheral direction.

In the Example, the length of the chute 11 is greater than the height of the convex lump so as to realize adjustment of length direction of the driving force receiver 2.

In the Example, the track groove 12 comprises a pin entrance groove 121 and a connecting groove 122. The pin entrance groove 121 extends downward from the top of the gear 1. The connecting groove 122 connects the pin entrance groove 121 and the chute 11. The protrusion 22 enters the chute 11 from the pin entrance groove 121 and the connecting groove 122.

In the Example, the connecting groove 122 is connected to the middle or lower part of the chute 11 from the bottom of the pin entrance groove 121.

In the Example, there are three protrusions 22, all of which are installed on the outer wall of the driving force receiver 2. The number of either the chute 11 or the track groove 12 is three, and each track groove 12 is corresponding to one chute 11.

The number of the of the protrusions 22 is a key inventive point of the invention. When the three protrusions 22 realize universal adjustment, there are always two protrusions 22 in touch with the chute 11 to achieve the purpose of position limit. Neither of two protrusions and four protrusions can achieve the effect of universal adjustment.

In the Example, the track groove 12 and the chute 11 are spaced and each track groove 12 lies in a position in clockwise rotational direction of the corresponding chute 11.

In the Example, the middle part of the gear 1 is installed with a terraced first blind hole 13. The chute 11 and track groove 12 are located on the wall of the first blind hole 13; the lower part of the driving force receiver 2 penetrates into the upper hole section of the first blind hole 13; when the protrusion 22 slides along the track groove 12, the driving force receiver 2 slides along the gear 1 axis.

In the Example, the chute 11 is connected to the bottom surface of the gear 1. When the step of the first blind hole 13 abuts against the bottom of the driving force receiver 2, the driving force receiver 2 reaches the first lower limit service position.

In the Example, an elastic piece 3 is further comprised. The lower part of the driving force receiver 2 is installed with a second blind hole 23 and the elastic piece 3 is installed between the first blind hole 13 and the second blind hole 23. The elastic piece 3 may be an elastic structure such as a spring and the like.

In the Example, when the elastic piece 3 reaches the limit of the state of compression, the driving force receiver 2 reaches the second lower limit service position.

In the Example, when the protrusion 22 lies in the upper limit service position and the first lower limit service position of the chute 11, the elastic piece 3 is in a state of compression.

In the Example, the elastic piece 3, i.e. the elastic buffer piece, is a metal spring. To those ordinarily skilled in the art, the elastic piece 3 may also be other elastic buffer mechanisms, such as rubber, metal shrapnel or compressed sponge, etc.

Functions of the elastic piece 3: preventing the driving force receiver 2 from disengaging during transport; allowing the driving force receiver 2 to shrink when putting into the cartridge; during centring, realizing self-calibration through coordination between the elastic shrinkage and extension of itself and the arc transition structure of the driving force receiving head 21; during work, ensuring close integration of the driving force receiver 2 and the driving force exporter and ensuring the transmission force; when the elastic piece 3 is installed between the driving force receiver 2 and the gear 1 and when the protrusion 22 lies at the joint of the track groove 12 and the chute 11, the elastic piece 3 is in the state of compression, which ensures that the protrusion 22 will not make lateral movement during work and avoids sliding out of the track groove 12.

In the Example, the protrusion 22 and the driving force receiver 2 are arranged integrally.

In the Example, the protrusion 22 is installed in the back of the driving force receiver 2 detachably.

### Example 2

A photosensitive drum driving component, comprising a gear 1 coordinating with the photosensitive drum and a driving force receiver 2 that can receive rotational driving force. The upper part of the driving force receiver 2 is installed with a driving force receiving head 21 and the outer wall at the lower part of the driving force receiver 2 projects more than three protrusions 22. The inner wall of the gear 1 is installed with more than three chutes 11 along the direction of the gear 1 axis. The top of the chute 11 is installed with a harrier structure and the side wall of the chute 11 is connected with a track groove 12 which connects the top of the gear 1 and the chute 11. Each protrusion 22 enters the chute 11 from the track groove 12 and may be installed as sliding along the track groove 12.

The protrusion 22 slides in the chute 11, which realizes rotational transmission between the driving force receiver and the gear structure. The driving force receiver is not easily disengaged from the gear structure and thus has a low failure rate and high stability. The invention further provides a cartridge comprising the photosensitive drum driving component.

In the Example, the barrier structure installed on top of the chute 11 is: a wall body on top surface of the chute 11. It has beneficial effects and a simple structure and can achieve the effect of preventing disengaging of the driving force receiver from the gear structure. When the protrusion 22 abuts against the top surface of the chute 11, the driving force receiver 2 reaches the upper limit service position.

In the Example, the depth of the chute 11 is greater than the projecting length of the protrusion 22 so as to realize swing of the driving force receiver in the radial direction.

In the Example, the protrusion 22 is a convex column and the width of the chute 11 is greater than the diameter of the convex column so as to realize slight swing of the driving force receiver 2 in the peripheral direction.

In the Example, the track groove 12 extends from the top of the gear 1 to the chute 11 in form of arc.

In the Example, there are three protrusions 22, all of which are installed on the outer wall of the driving force receiver 2. The number of either the chute 11 or the track groove 12 is three, and each track groove 12 is corresponding to one chute 11.

In the Example, the track groove 12 and the chute 11 are spaced and each track groove 12 lies in a position in clockwise rotational direction of the corresponding chute 11.

In the Example, the middle part of the gear 1 is installed with a terraced first blind hole 13. The chute 11 and track groove 12 are located on the wall of the first blind hole 13; the lower part of the driving force receiver 2 penetrates into the upper hole section of the first blind hole 13; when the protrusion 22 slides along the track groove 12, the driving force receiver 2 slides along the gear 1 axis.

In the Example, the chute 11 is connected to the bottom surface of the gear 1. When the step of the first blind hole 13 abuts against the bottom of the driving force receiver 2, the driving force receiver 2 reaches the first lower limit service position.

In the Example, an elastic piece 3 is further comprised. The lower part of the driving force receiver 2 is installed with a second blind hole 23 and the elastic piece 3 is installed between the first blind hole 13 and the second blind hole 23.

In the Example, when the elastic piece 3 reaches the limit of the state of compression, the driving force receiver 2 reaches the second lower limit service position.

In the Example, when the protrusion 22 lies in the upper limit service position and the first lower limit service position of the chute 11, the elastic piece 3 is in a state of compression.

In the Example, the protrusion 22 and the driving force receiver 2 are arranged integrally.

In the Example, the protrusion 22 is installed in the back of the driving force receiver 2 detachably.

The invention further provides a cartridge.

The cartridge (a cartridge of a printer) is applied in an electrophotographic image forming device and is detachably installed in the electrophotographic image forming device. It comprises a photosensitive member arranged along the longitudinal direction of the cartridge, and a rotational force driving component installed at one end of the photosensitive member and used for being engaged with a rotational force driving head inside the electrophotographic image forming device so as to transmit force to the photosensitive member. The rotational force driving component is a photosensitive drum driving component.

In the Example, the photosensitive drum driving component comprises a gear 1 coordinating with the photosensitive drum, and a driving force receiver 2 that can receive the driving force. The upper part of the driving force receiver 2 is installed with a driving force receiving head 21 and the outer wall at the lower part of the driving force receiver 2 projects more than three protrusions 22. The inner wall of the gear 1 is installed with more than three chutes 11 along the direction of the gear 1 axis. The top of the chute 11 is installed with a barrier structure and the side wall of the chute 11 is connected with a track groove 12 which connects the top of the gear 1 and the chute 11. Each protrusion 12 enters the chute 11 from the track groove 12 and may be installed as sliding along the track groove 12.

The protrusion 22 slides in the chute 11, which realizes rotational transmission between the driving force receiver and the gear structure. The driving force receiver is not easily disengaged from the gear structure and thus has a low failure rate and high stability. The invention further provides a cartridge comprising the photosensitive drum driving component.

In the Example, the barrier structure installed on top of the chute 11 is: a wall body on top surface of the chute 11. It has beneficial effects and a simple structure and can achieve the effect of preventing disengaging of the driving force receiver from the gear structure. When the protrusion 22 abuts against the top surface of the chute 11, the driving force receiver 2 reaches the upper limit service position.

In the Example, the depth of the chute 11 is greater than the projecting length of the protrusion 22 so as to realize swing of the driving force receiver in the radial direction.

In the Example; the protrusion 22 is a convex column and the width of the chute 11 is greater than the diameter of the convex column so as to realize slight swing of the driving force receiver 2 in the peripheral direction.

In the Example, the track groove 12 extends from the top of the gear 1 to the chute 11 in form of arc.

In the Example, there are three protrusions 22, all of which are installed on the outer wall of the driving force receiver 2. The number of either the chute 11 or the track groove 12 is three, and each track groove 12 is corresponding to one chute 11.

In the Example, the track groove 12 and the chute 11 are spaced and each track groove 12 lies in a position in clockwise rotational direction of the corresponding chute 11.

In the Example; the middle part of the gear 1 is installed with a terraced first blind hole 13. The chute 11 and track groove 12 are located on the wall of the first blind hole 13; the lower part of the driving force receiver 2 penetrates into the upper hole section of the first blind hole 13; when the protrusion 22 slides along the track groove 12, the driving force receiver 2 slides along the gear 1 axis.

In the Example, the chute 11 is connected to the bottom surface of the gear 1. When the step of the first blind hole 13 abuts against the bottom of the driving force receiver 2, the driving force receiver 2 reaches the first lower limit service position.

In the Example, an elastic piece 3 is further comprised. The lower part of the driving force receiver 2 is installed with a second blind hole 23 and the elastic piece 3 is installed between the first blind hole 13 and the second blind hole 23.

In the Example, when the elastic piece 3 reaches the limit of the state of compression, the driving force receiver 2 reaches the second lower limit service position.

In the Example, when the protrusion 22 lies in the upper limit service position and the first lower limit service position of the chute 11, the elastic piece 3 is in a state of compression.

In the Example, the protrusion 22 and the driving force receiver 2 are arranged integrally.

In the Example, the protrusion 22 is installed in the back of the driving force receiver 2 detachably.

In the Example, the driving force receiver 2 comprises two convex claws. The top of a driving force transmitter 5 is installed with a pinhole 51. Pin 6 penetrates through the pinhole. The length of the pin 6 is greater than the length of the pinhole 51, so both ends of the pin 6 come out of the pinhole 51. The driving force is transmitted through engaging of both ends of the pin 6 with the convex claws of the driving force receiver 2.

In the Example, the gear 1 integrates with the photosensitive drum to realize the purpose of driving the photosensitive drum to rotate by the gear 1.

The invention is not restricted to the above Examples. The technical solutions of each of the above Example in the invention can cross and integrate with each to form new technical solutions. Besides, all technical solutions formed through equivalent replacement fall within the protection scopes of the invention.

1. A photosensitive drum driving component comprising a gear coordinating with a photosensitive drum and a driving force receiver that can receive rotational driving force, characterized in that the upper part of the driving force receiver is installed with a driving force receiving head; the outer wall at the lower part of the driving force receiver projects three protrusions; the inner wall of the gear is installed with three chutes along the direction of the gear axis; the top of the chute is installed with a barrier structure; the side wall of the chute is connected with a track groove which connects the top of the gear and the chute; each of the protrusion enters the chute from the track groove and may be installed as sliding along the track groove.

2. The photosensitive drum driving component according to claim 1, characterized in that the barrier structure installed on top of the chute is: a wall body on the top surface of the chute; when the protrusion abuts against the top surface of the chute, the driving force receiver reaches an upper limit service position.

3. The photosensitive drum driving component according to claim 1, characterized in that the depth of the chute is greater than the projecting length of the protrusion;
the protrusion is a convex lump and the width of the chute is greater than the width of the convex lump; or
the protrusion is a convex column and the width of the chute is greater than the diameter of the convex column.

4. The photosensitive drum driving component according to claim 1, characterized in that the track groove extends from the top of the gear to the chute in form of arc.

5. The photosensitive drum driving component according to claim 1, characterized in that the track groove comprises a pin entrance groove and a connecting groove, wherein the pin entrance groove extends downward from the top of the gear; the connecting groove connects the pin entrance groove and chute; the protrusion enters the chute from the pin entrance groove and the connecting groove.

6. The photosensitive drum driving component according to claim 5, characterized in that the connecting groove is connected to the middle or lower part of the chute from the bottom of the pin entrance groove.

7. The photosensitive drum driving component according to claim 5, characterized in that said three protrusions are installed on the outer wall of the driving force receiver; and said three, chute and track grooves are disposed such that each track groove corresponds to one of the chutes.

8. The photosensitive drum driving component according to claim 7, characterized in that the track groove and chute are spaced and each track groove lies in a position in clockwise rotational direction of the corresponding chute.

9. The photosensitive drum driving component according to claim 1, characterized in that the middle part of the gear is installed with a terraced first blind hole; the chute and the track groove are located on the wall of the first blind hole; the lower part of the driving force receiver penetrates into an upper hole section of the first blind hole; when the protrusion slides along the track groove, the driving force receiver slides along the gear axis.

10. The photosensitive drum driving component according to claim 9, characterized in that the chute is connected to the bottom surface of the gear; when a step of the first blind hole abuts against the bottom of the driving force receiver, the driving force receiver reaches a first lower limit service position.

11. The photosensitive drum driving component according to claim 9, characterized in that an elastic piece is further comprised; the lower part of the driving force receiver is installed with a second blind hole and the elastic piece is installed between the first and second blind holes.

12. The photosensitive drum driving component according to claim 11, characterized in that when the elastic piece reaches the limit of the compression state, the driving force receiver reaches a second lower limit service position.

13. The photosensitive drum driving component according to claim 11, characterized in that when the protrusion lies in the upper limit service position and the first lower limit service position of the chute, the elastic piece is in a compression state.

14. The photosensitive drum driving component according to claim 1, characterized in that the protrusion and the driving force receiver are arranged integrally.

15. The photosensitive drum driving component according to claim 1, characterized in that the protrusion is installed in the back of the driving force receiver detachably.

16. A cartridge, applied in an electrophotographic image forming device and detachably installed in the electrophotographic image forming device, comprising a photosensitive member arranged along the longitudinal direction of the cartridge, and a rotational force driving component installed at one end of the photosensitive member and used for being engaged with a rotational force driving head inside the electrophotographic image forming device, characterized in that the rotational force driving component is the photosensitive drum driving component according to claim 1.

17. A cartridge, applied in an electrophotographic image forming device and detachably installed in the electrophotographic image forming device, comprising a photosensitive member arranged along the longitudinal direction of the cartridge, and a rotational force driving component installed at one end of the photosensitive member and used for being engaged with a rotational force driving head inside the electrophotographic image forming device, characterized in that the rotational force driving component is the photosensitive drum driving component according to claim 3.

18. A cartridge, applied in an electrophotographic image forming device and detachably installed in the electrophotographic image forming device, comprising a photosensitive member arranged along the longitudinal direction of the cartridge, and a rotational force driving component installed at one end of the photosensitive member and used for being engaged with a rotational force driving head inside the electrophotographic image forming device, characterized in that the rotational force driving component is the photosensitive drum driving component according to claim 5.

19. A cartridge, applied in an electrophotographic image forming device and detachably installed in the electrophotographic image forming device, comprising a photosensitive member arranged along the longitudinal direction of the cartridge, and a rotational force driving component installed at one end of the photosensitive member and used for being engaged with a rotational force driving head inside the electrophotographic image forming device, characterized in that the rotational force driving component is the photosensitive drum driving component according to claim 11.
